(19) United States
(12) Patent Application Publication
(10) Pub. No.: US 2014/0047693 A1
(43) Pub. Date: Feb. 20, 2014

(54) ANTI-TOPPLING TETHER: APPARATUS AND METHOD

(71) Applicants: Timothy M. Cassidy, Plymouth, MN (US); Yang Du, Shenzhen (CN)

(72) Inventors: Timothy M. Cassidy, Plymouth, MN (US); Yang Du, Shenzhen (CN)

(73) Assignee: BBY SOLUTIONS, Richfield, MN (US)

(21) Appl. No.: 13/588,149

(22) Filed: Aug. 17, 2012

(51) Int. Cl. F16M 13/02

(52) U.S. Cl. CPC F16M 13/02
USPC 29/428; 248/201

(57) ABSTRACT

The tether of the present invention can prevent an appliance, such as a television or monitor, from toppling off furniture, such as a dresser, upon which the appliance rests. The tether attaches to the appliance and to the wall using surface-mounts. Embodiments of the tether may include some or all of the following features: (1) a length-adjuster to facilitate a snug fit; (2) loops and elastic components to maintain tautness while permitting tilt and swivel of the electronic device; (3) quick-release(s) to allow the electronic device to be moved without having to detach the surface-mounts from the wall or from the electronic device; (4) an adhesive surface for easy installation. Methods for using the tether are described.

### FIELD OF THE INVENTION

The present invention relates to child safety protection. More specifically, it relates to a tether that prevents a television, appliance, or other appliance from toppling.

### BACKGROUND OF THE INVENTION

Injuries due to instability of furniture are a significant problem, particularly for children. When a heavy electronic device, such as a large flat-screen television, sits atop a piece of furniture, the combination has an elevated center of gravity, significantly exacerbating the danger. Jostling of the furniture may cause the television, and possibly the furniture as well, to topple.

### SUMMARY OF THE INVENTION

Certain terminology that is used in the specification and claims of this document are clarified here at the outset. For our purposes, the word “incident” means a safety incident potentially involving toppling of the piece of furniture or the electronic device that rests upon it. When we say something can be done “manually without tools”, this is stronger than mere feasibility. It implies that it can be done conveniently, without unreasonable effort, by an ordinary adult. We use the term “appliance” in the general sense of a “device designed to perform a specific task.” The terms “loop” and “ring” will be used interchangeably to describe a structure that encloses an opening; the structure and/or the opening may/may not have curvature. A “set” includes zero or more elements. A “nonempty” set contains at least one element. A “subset” of a set may be a proper subset, which has fewer elements than the set, or an improper subset, which is identical to the set. The word “or” is used inclusively, unless otherwise clear from the context; if A or B is true, then A is true, B is true, or A and B are true.

A safety device is more likely to be used if it is convenient, as well as serving the purpose for which it is intended. The anti-toppling tether invention described herein targets both these goals. In general, embodiments of the tether can be used to restrain any kind of bulky appliance, such as a large electronic device. Without loss of generality, however, we will for convenience use a flat panel appliance (e.g., a computer appliance) or television (TV) in much of the further discussion. We assume that the TV is situated on a piece of furniture, such as a dresser or chest that is close to, or against a wall. The discussion that follows pertains also if the furniture is close to vertical surface other than a wall, such as a partition. We assume that the wall or vertical surface is sufficiently rigid and stable that it will not topple during an incident.

If the furniture is rocked or itself gets toppled, ideally the TV would simply stay put. However, the type of restraint that would achieve this safety ideal would (1) be expensive; (2) require experience with hand tools and the ability to follow written instructions for installation; (3) probably require drilling into a wall, which is a particular problem for renters, or into furniture; (4) significantly diminish certain functionalities of the TV, such as swivel and tilt; and (5) effectively lock the TV into a single location in the home because the restraint will have to be at least partially uninstalled (and later reinstalled) to temporarily relocate the TV (e.g., to enjoy a sports event with guests in a different room). Each of these negative factors alone will discourage a significant percentage of consumers; only the most conscientious parents are likely to purchase, successfully install, and diligently use a device that inflicts all five factors in combination.

Consider an incident where a child rocks a tall, marginally stable, dresser upon which a large, heavy, flat-screen TV rests. Note that in such a case, rigidly and permanently anchoring the TV to the top of the dresser is a bad idea—this configuration will almost guarantee that both the furniture and TV will topple. Of course, if the furniture piece is heavy and well-made, then such anchoring might work, but who wants to drill into their quality furniture? If the TV is unrestrained, then the TV might topple even if the furniture does not fall. In both of these worst-case scenarios, the TV moves away from the wall, beyond the initial outward surface location of the furniture before it was disturbed.

If the TV can be constrained in the above incident so that it tends to fall inward and downward, rather than outward, then most tragedies of this type can be avoided. By limiting the safety goal pragmatically, some or all of the five negative factors above can be eliminated. Also, even a tether that does not fully support the weight of the equipment or appliance to which it is attached may offer sufficient restraint to protect that object from any damage whatsoever in a substantial number of incidents.

A tether of the invention is a set of straps, or belts, and other components that form a single connected assembly when the tether is in operation, restraining the appliance. The components may include, for example, one or more surface-mounts, length-adjusters, elastic components, loops, quick-releases, and various connectors. The surface-mounts include at least one mount for attaching the tether to a wall and one mount for attaching the tether to the appliance (e.g., TV, appliance, other electric device). The mounts may fasten with hardware (e.g., screws, bolts, staples), but preferably they include an adhesive surface for easy attachment. While the adhesive surface may not alone support the weight of the device, it should be enough to keep the appliance from toppling even if the mount becomes detached from the wall or appliance in an incident. The adhesive surface may be protected with a cover that can easily be peeled off. Such mounts can be easily and intuitively installed without hand tools or mechanical experience. They can also be relatively easily be removed from the appliance and from the wall.

A variety of configurations for the straps are described in the Detailed Description section. The TV may have between 1 and 4 attachment points, where a surface-mount attaches the tether to an appliance surface external to the tether; likewise for a wall surface. One exemplary embodiment has two attachment points on the TV, and one on the wall. Another has one attachment point on the TV, and two on the wall.

A length-adjuster allows the length of a strap segment in the tether to be adjusted so that the tether fits in the space between the TV and the wall and is reasonably taut. Length adjustment may be done in a variety of ways, including for example, a slide, a buckle, or a hook-and-loop fastener such as VELCRO®.

An elastic component, such as a strip of elastic material or a spring, may be used to compensate for distance changes resulting from swivel and tilt of the TV. The elastic component should have a stiffness that allows elongation and shortening so as to maintain reasonable tautness within normal operating uses, particularly rotations. The elastic component should be strong enough to not break easily in an incident, thereby diminishing the overall safety effectiveness of the tether. An elastic component can also help prevent damage to the appliance it secures under some circumstances. In an earthquake, for example, an appliance that is rigidly secured by a tether to a wall is much more likely to suffer damage than one that has some freedom of movement independent of structural elements; similarly, if furniture on which the appliance rests is jostled, but does not fall.

A loop may be included at some location in the tether. A strap may slide freely through the opening in the loop to facilitate the TV being swiveled or tilted.

One or more quick-releases in the tether may allow the TV to be conveniently removed manually without tools from being held to the wall by the tether. A quick-release might be, for example, a clasp, a “snap hook”, a hook, a buckle, a snap, a button, or a hook-and-loop fastener. In embodiments having this feature, decoupling quick-releases from respective elements to which they attach will separate the tether into two or more subassemblies, without requiring removal of the surface-mounts on the wall or the TV. The quick-releases also allow easy recoupling to again restrain the appliance. In some embodiments, releasing a single quick-release decouples all the wall mounts from all the appliance mounts.

Processes utilize embodiments that incorporate various combinations of these features.

### BRIEF DESCRIPTION OF THE DRAWINGS

FIG. 1a is a top view of an anti-toppling tether securing an appliance, in this case a TV or monitor, to a wall, wherein two surface-mounts are visible on the appliance and one surface mount is visible on the wall. A swivel axis is also illustrated.

FIG. 1b is a top view of an anti-toppling tether securing an appliance to a wall, wherein one surface-mount is visible on the wall and one surface mount is visible on the appliance.

FIG. 1c is a top view of an anti-toppling tether securing an appliance to a wall, wherein two surface-mounts are visible on the wall and one surface mount is visible on the appliance.

FIG. 1d is a top view of an anti-toppling tether securing an appliance to a wall, wherein three surface-mounts are visible on the appliance and one surface mount is visible on the wall.

FIG. 1e is a top view of an anti-toppling tether that incorporates elastic components and secures an appliance to a wall.

FIG. 1f is a top view of an anti-toppling tether that incorporates an elastic component near a wall mount, and secures an appliance to a wall.

FIG. 1g is a top view of an anti-toppling tether that incorporates an elastic component near an appliance mount, and secures an appliance to a wall.

FIG. 2a is a side view of an anti-toppling tether securing an appliance to a wall, illustrating a tilt axis of the appliance.

FIG. 2b is a side view of an anti-toppling tether securing an appliance to a wall, wherein one surface-mount is visible on the wall and one surface mount is visible on the appliance.

FIG. 2c is a side view of an anti-toppling tether securing an appliance to a wall, wherein two surface-mounts are visible on the screen portion of the appliance and one surface mount is visible on the wall.

FIG. 2d is a side view of an anti-toppling tether securing an appliance to a wall, wherein two surface-mounts are visible on the appliance—one on the screen portion and the other on the stand—and one surface mount is visible on the wall.

FIG. 2e is a side view of an anti-toppling tether securing an appliance to a wall and incorporating an elastic component attached to a wall mount.

FIG. 2f is a side view of an anti-toppling tether securing an appliance to a wall and incorporating an elastic component attached to an appliance mount.

FIG. 3a is a back view of an appliance to which a surface-mount attaches at one point.

FIG. 3b is a back view of an appliance to which surface-mounts attach at two points.

FIG. 3c is a back view of an appliance to which surface-mounts attach at three points.

FIG. 3d is a back view of an appliance to which surface-mounts attach at four points.

FIG. 4a is a side view of a surface-mount with a rectangular loop through which a tether strap (in cross section) passes.

FIG. 4b is a side view of a surface-mount with a D-shaped loop.

FIG. 5 is a front view of a surface-mount through which a tether strap passes.

FIG. 6a is a clasp that might be used to connect a tether strap to a tether mount.

FIG. 6b is a clasp that might be used to connect a tether strap to a tether mount. This clasp includes a rectangular loop, through which the strap may freely slide.

FIG. 7 is a D-ring that might be used to connect components of a tether.

FIG. 8 is a top view of a slide for length-adjustment.

FIG. 9 is a conceptual view showing a topology of a tether strap, two surface-mounts, and a length-adjustment slide.

FIG. 10 illustrates a coupling between a strap section and elastic material.

FIG. 11 illustrates a coupling between a strap section and a spring.

FIG. 12 illustrates a coupling between a surface mount and a spring.

FIG. 13 illustrates a coupling between a surface mount, a clasp, and a spring.

FIG. 14 illustrates a coupling between a surface mount, a clasp, and elastic material.

FIG. 15a illustrates an ordering of components that might be used in a portion of an anti-toppling tether.

FIG. 15b illustrates an ordering of components that might be used in a portion of an anti-toppling tether.

FIG. 15c illustrates an ordering of components that might be used in a portion of an anti-toppling tether.

FIG. 15d illustrates an ordering of components that might be used in a portion of an anti-toppling tether.

FIG. 15e illustrates an ordering of components that might be used in a portion of an anti-toppling tether.

FIG. 16 describes some advantages of various embodiments of the invention.

FIG. 17 lists steps such that any combination of these steps with an embodiment of an apparatus of the invention is a process embodiment.

FIG. 18 is a diagram that illustrates loss of strap tautness as a monitor is swiveled away from a standard orientation in some embodiments.

FIG. 19 is a chart derived from the previous figure, for the case of w=50 units (e.g., inches) and d=25 units.

### DETAILED DESCRIPTION OF EXEMPLARY EMBODIMENTS

This description provides embodiments of the invention intended as exemplary applications. The reader of ordinary skill in the art will realize that the invention has broader scope than the particular examples described here. For example, we will use flat-screen appliances (e.g., television appliances or computer appliances) throughout for illustration. However, the scope of the invention encompasses other appliances or pieces of equipment.

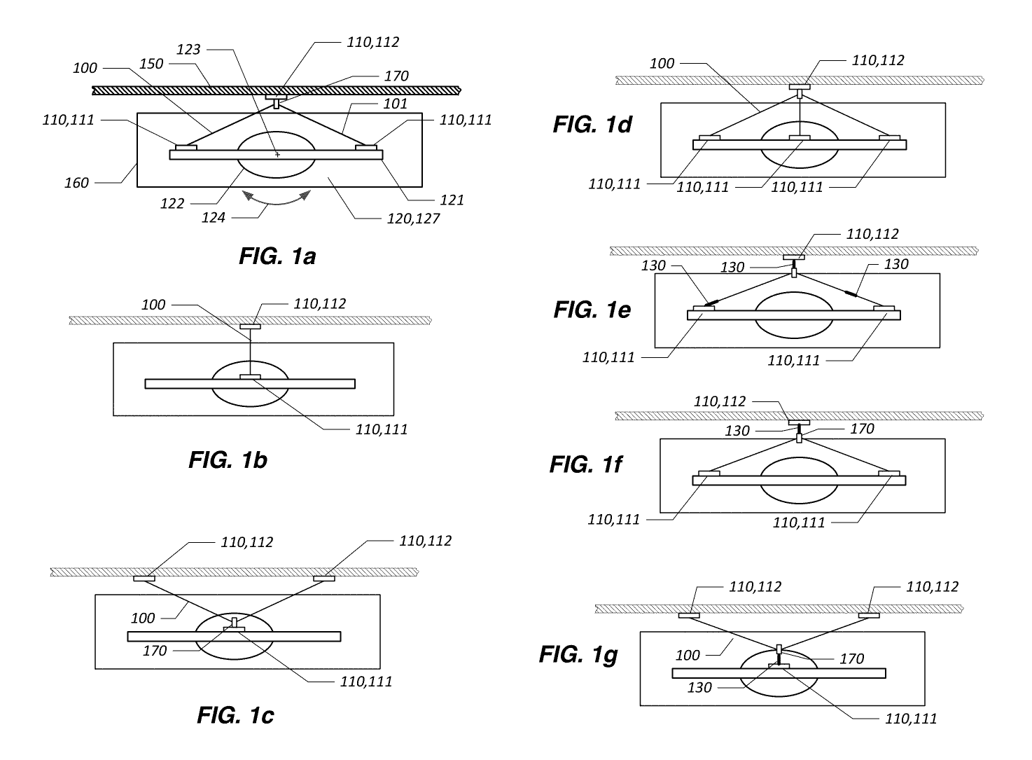

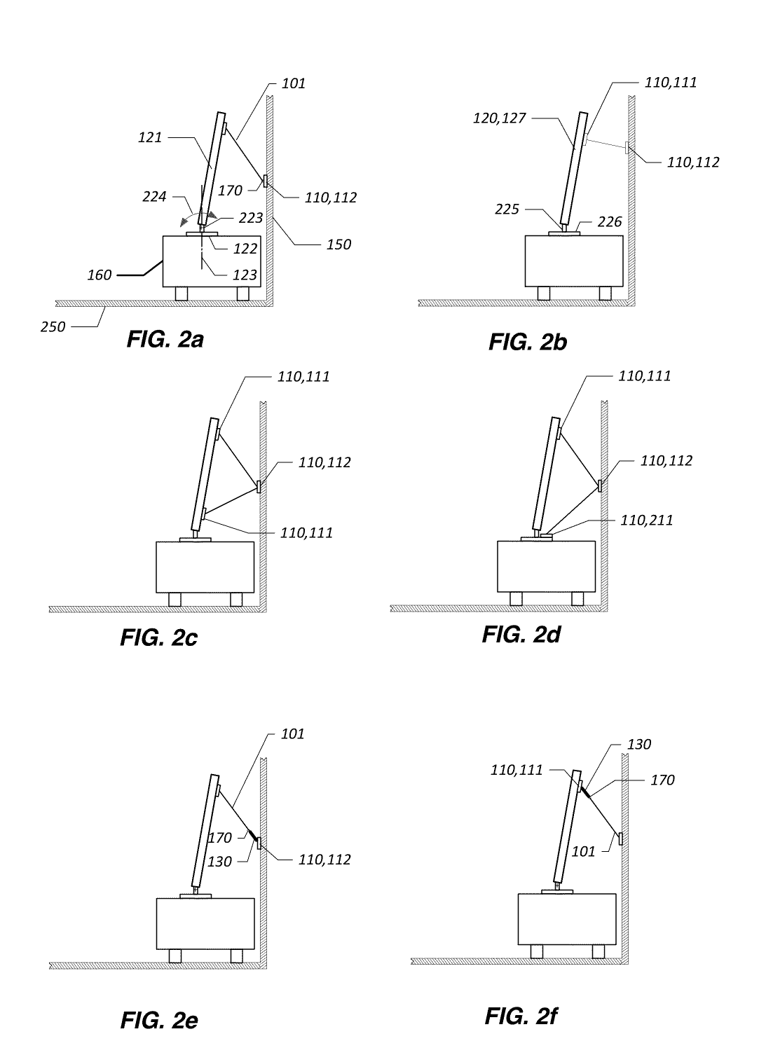

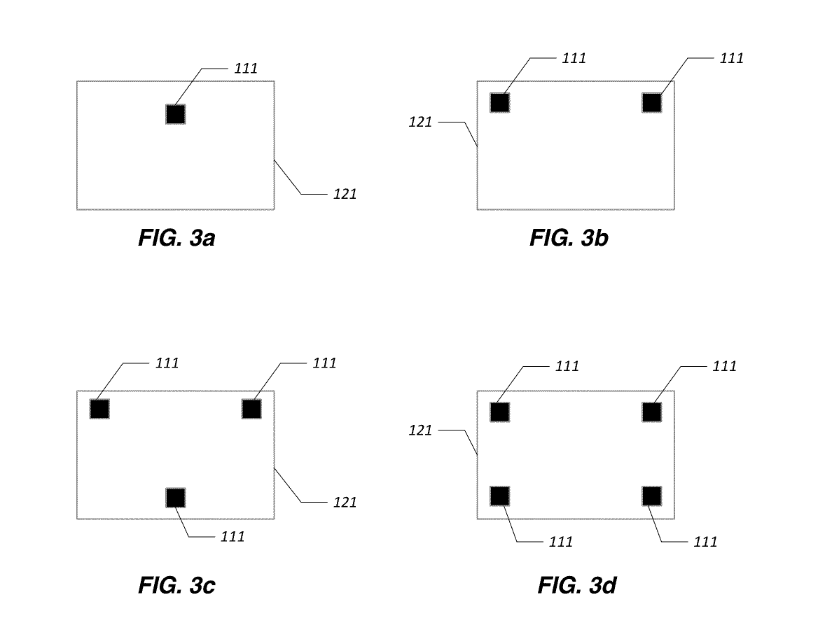

FIG. 1a-1g illustrate top views of various embodiments of an anti-toppling tether 100 and FIG. 1e-2f show some possible side views. In each case, a tether 100 attaches an appliance 120 to a wall 150. FIG. 3a-3d show some exemplary mount 110 layouts on the rear of a flat-screen monitor 127. A similar variety of mount layouts on a wall 150 are possible. Combining any one of the top views with any one of the side views results in a set of embodiments within the scope of the invention. In most cases, any such embodiment can be further combined with an appliance mount 111 layout chosen from FIG. 3a-3d and a similar wall mount 112 layout (not shown) to give a set of embodiments. Configurations other than these combinations are also within the inventive concept.

In each of these figures, we assume that the monitor 127 rests on top of a piece of furniture 160, or a shelf or other horizontal surface. Because elements of FIG. 1a typify this group of figures, some reference numbers have been omitted from the others for visual clarity. The anti-toppling tether 100 includes at least one strap 101 or belt, one surface-mount 110 for attaching to a wall 150 or other surface, one surface-mount 110 for attaching to a monitor 127 or other appliance. Our drawings will sometimes depict surface-mounts 110 for attachment to a wall 150 (i.e., wall mounts 112) with symbols similar or identical to surface-mounts 110 for attachment to an appliance 120 (i.e., appliance mounts 111). That is for convenience only, since a wall mount 112 might differ from an appliance mount 111 in shape, size, or method of attachment. Likewise for convenience and without loss of generality, embodiments are shown in which surface-mounts 110 are rectangular.

A strap 101 will preferably be made from a fabric, such as a synthetic material (e.g., webbing or strip made from nylon, polyester, or polypropylene), or a natural fabric (e.g., cotton), or some combination or blend thereof. A strap 101 might also be made of leather or rubber. A tether 100 might include two or more straps 101, and these may include a single or a plurality of materials.

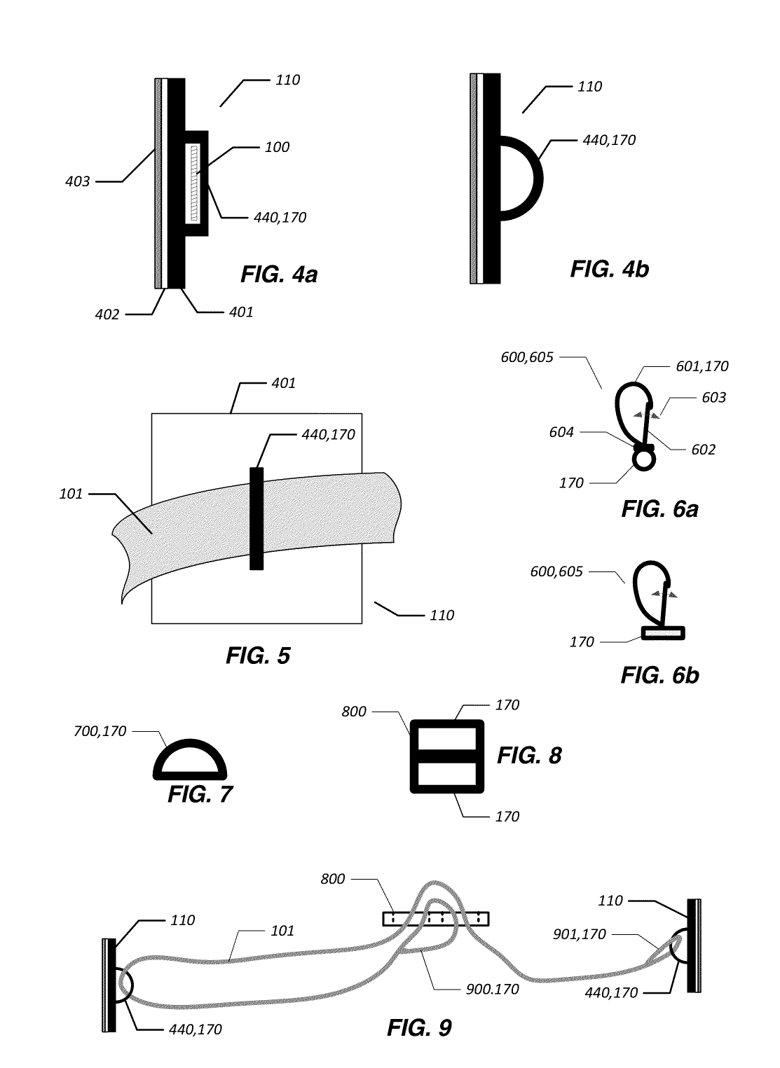

When the tether 100 is in operation restraining the monitor 127, the strap 101 and the two surface-mounts 110 are directly or indirectly physically connected to each other by the tether 100. More generally, the components of the tether 100, including for example, various hardware elements such as those shown in FIG. 4b-14, are joined together into a single interconnected assembly when the tether 100 is in a restraining configuration.

A typical flat-screen monitor 127 has internal hardware structures that allow it to rotate both horizontally (“swivel”) and vertically (“tilt”). These structures, and the corresponding rotation axes, are usually found in a stand 122 or base of the monitor 127. The particular monitors 127 in FIG. 1a-1d each have a screen 121 portion that, for convenience in illustration, happens to be vertical, parallel to the surface of the wall 150. The monitor 127 can swivel around the swivel axis 123 in the directions shown by arrow 124.

Note that from the top view perspective of FIG. 1a-1g, a single strap 101 or a single mount 110 may obscure others below. So, for example, the embodiments represented by FIG. 1b might have one strap 101 (i.e., the one shown), or two or more straps 101, within the scope of the invention. In the next several paragraphs, however, we will focus on those particular instances of FIG. 1a-1g in which the straps 101 seen in the top views do not obscure others directly below them.

FIG. 1a shows two appliance mounts 111 attached to the screen portion 121 of the monitor 127. A strap 101 extends from one appliance mount 111 (e.g., the one to the left) to the wall mount 112. Although that strap 101 might end at the wall mount 112 with some attachment, alternatively it might, as shown, pass through a loop 170 (see, e.g., FIGS. 4a, 4b, 5, and 9) and continue to the other appliance mount 111. In this case, the loop 170 acts to guide the strap 101 in lateral motion, but to prevent motion of the appliance 120 outward from the wall.

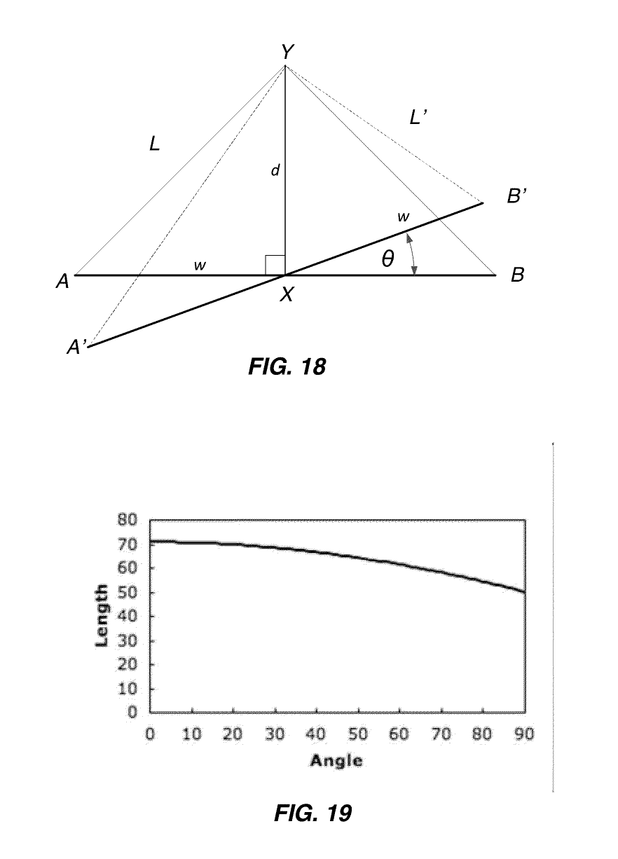

The approach allows the monitor 127 to swivel while the tether 100 is in place, although any swiveling relative to a “standard” orientation of the monitor 127 in which the screen 121 is parallel to the wall 150 (or more precisely, in which the respective distances from the first and second appliance mounts 111 to a loop 170 attached either directly to a wall mount 112, or attached to an elastic component 130 that is attached to the wall mount 112, are equal) will result in a reduction in tautness of the strap 101. This is illustrated by FIGS. 18 and 19. In FIG. 18, A and B represent positions of two wall mount 112, as in FIG. 1a, when the monitor 127 is in the standard orientation. The distance between A and B is w. X represents at the midpoint of the monitor 127. Y represents the point on the loop 170 of a wall mount 112 corresponding to a perpendicular dropped from X. The width of A-B is w. The distance between X and Y is d. The total strap length from A to Y, then to B is L. If the monitor 127 is swiveled through an angle θ, then the wall mounts 112 are now at A′ and B′. The total length from A′ to Y, then to B′ is L′.

It can be proved mathematically that L′<L. In fact, for any values of w and d, L′ decreases smoothly to a minimum value when θ is 90 deg. FIG. 19 shows the length L′ as a function of angle for a couple particular values, namely, w=50 and d=25.

Such loss of tautness implies that the tether 100 may have no restraining effect in the first few seconds of an incident when the monitor 127 has been swiveled away from the position where it is parallel to the wall 150. Other than the tautness loss problem, the geometry of FIG. 1a is a relatively stable one.

The tether 100 of FIG. 1b, with a single strap 101, one wall mount 112, and one appliance mount 111, is the simplest configuration. While it probably is the least stable, it is better than nothing, and is inexpensive to produce. It also allows the monitor 127 to swivel to the maximum extent and without loss of tautness of the strap 101.

The tether 100 of FIG. 1c has a loop 170 arrangement similar to that of FIG. 1a, facilitating swivel. Swivel will have a relatively negligible length on tautness, another advantage of this tether 100 configuration. Because there is only one surface-mount 110 on the monitor 127, it may have somewhat less restraining efficacy than the tether 100 of FIG. 1a.

The tether 100 of FIG. 1c has a loop 170 arrangement similar to that of FIG. 1a, facilitating swivel. Swivel will have a relatively negligible length on tautness, another advantage of this tether 100 configuration. Because there is only one surface-mount 110 on the monitor 127, it may have somewhat less restraining efficacy than the tether 100 of FIG. 1a.

The tether 100 of FIG. 1d is similar to FIG. 1a, but with three wall mounts 112. While it suffers from the same swivel/tautness issue as the tether 100 of FIG. 1a, but with more appliance mounts 111 it is more stable, and also more expensive to produce.

As with the tether 100 top views already discussed, due to the perspective in the side views of FIG. 2a-2f, a single visible strap 101 may obscure others that are aligned horizontally with that strap 101. (Some reference numbers that are redundant in FIG. 2a-2f are omitted for visual clarity.) So some embodiments of FIG. 2c are consistent with some embodiments of FIG. 1a and FIG. 1d.

FIG. 2a is a side view of a monitor 127 resting on furniture 160, which in turn is supported by the floor 250. The monitor 127 has a screen portion 121, which is attached to a stand 122. The stand 122 has a column 225 and a base 226 (as shown in FIG. 2b). In this tether 100, the screen portion 121 can tilt around tilt axis 223, located in the column 225, as well as swivel around swivel axis 123. Assuming that the tether 100 is taut and rigid, however, the monitor 127 can tilt backward (clockwise, from our perspective), but the tether 100 will lose tautness when that occurs. The monitor 127 cannot tilt forward (counterclockwise) at all, without moving the base 226.

In FIG. 2d, an appliance mount 111 is shown attached to the base 226 rather than to the screen portion 121 of the monitor 127.

FIGS. 1e, 1f, 2e, and 2f show tethers 100 that incorporate elastic components 130 to facilitate better swivel and tilt, while maintaining tether 100 strap tautness. An elastic component 130 might be, for example, any elastic material such as elastic fabric or a rubber strip, a spring 1100, or a bungee/shock cord. The elastic component 130 may be connected within a tether 100 to a strap 101 or a mount 110, possibly with other hardware components. Some possible configurations are described in connection with FIG. 4a-14. Although the configuration of FIG. 1e is unrealistic, it shows three elastic components 130 that do illustrate a few of the possible locations within the tether 100 where they could be located.

The layouts of FIGS. 1f, 2e, and 3b, considered as a combined configuration, address the swivel and tilt issues mentioned above. In this combined configuration, a strap 101 can slide freely through a loop 170 attached to an elastic component 130, which in turn is attached to a wall mount 112. If the elastic component 130 is appropriately stretched when the monitor 127 is in the standard alignment, then the elastic component 130 can maintain tautness when the monitor 127 is swiveled away from the standard orientation. The elastic component 130 can extend further to allow counterclockwise tilt, or contract to take up slack if the screen 121 is tilted clockwise. To facilitate these effects, the elastic component 130 used must be chosen to have appropriate length, stiffness, elasticity, and strength. A loop 170 attached to the outward end of the elastic component 130 guides lateral motion of the strap 101 when the monitor 127 is swiveled. The elastic component 130 may incorporate, or be attached to, a quick release 600 on either end. If so, then the tether 100 can be easily detached from the wall 150 at a single release point.

Another configuration that addresses the swivel and tilt issues is the combination of views from FIGS. 1g, 2f, and 3a. In this configuration, length reduction due to swivel is not a significant problem, since there is a single appliance mount 111. Tilt is facilitated by an elastic component 130 attached to the strap 101 and to the appliance mount 111. Again, a strap 101 passes freely through a loop 170 (that is, the strap 101 is not attached to the loop 170 enclosure), facilitating swivel. This configuration may also incorporate a quick release 600, possibly a single point quick release 600.

FIG. 4a-14 show exemplary components that might be included in an anti-toppling tether 100. In FIG. 4a, a strap 101, shown in cross-section, passes through a loop 170 in a surface-mount 110. The tether 100 might be configured so that such a mount 110 is used as an appliance mount 111 (e.g., as in FIG. 1c), or it might be configured so that the mount 110 is used as a wall mount 112 (e.g., as in FIG. 1a). This mount 110 includes a base 226 portion that includes, or is attached, to the loop 170; an adhesive layer 402; and a peel-off protective cover layer 403 (similar to the cover layer protecting the adhesive in a bandage strip). Note that a mount 110 might alternatively attach to a surface with other kinds of fasteners, such as screws, bolts, clamps. The, geometry, configuration, and means for attaching different appliances 120 with a given tether 100, and between different tethers 100, may vary.

The loop 170 in FIG. 4a is rectangular. FIG. 4b demonstrates that other shapes are possible, such as the D-shaped loop 170 shown. FIG. 5 shows the front view of a surface-mount 110 and a strap 101 passing through its loop 170. This figure could be the top view corresponding to either FIG. 4a or FIG. 4b.

The tether 100 may be equipped with one or more quick release 600 structures. A quick release 600 can be used to decouple the appliance 120 from the wall 150, without removal of at least one surface-mount 110 or appliance mount 111. For example, a person might want to move the appliance 120 for cleaning, or to temporarily move it for use in another location. Such embodiments of the tether 100, therefore, have a “restraining” or “operable” configuration, for restraining the appliance, and a “split” configuration (or possibly a plurality of split configurations) in which the appliance can be conveniently moved.

A quick release 600 might be integrated into some other component, as in the hook 601 integrated into a spring 1100, shown in FIG. 12; or it might be a separate component, such as the snap hooks 605 of FIGS. 6a and 6b. A snap hook 605 is a type of clasp, similar to a kind of “lobster” clasp, used in jewelry. Indeed, any such jewelry clasp might be used as a quick release 600. Note that all the hardware items found in FIGS. 4a-14 might be fashioned from any natural or man-made material, or combination thereof, used in the art for hardware construction, for example, metal, plastic, glass, or fiberglass.

The snap hook 605 of FIG. 6a includes a hook 601 portion, an arm 602, a pivot 604, and a loop 170. The arm 602 may be depressed to give access to the hook 601 portion, allowing the snap hook 605 to be attached, for example, to a loop 170 or strap 101. When the user releases the arm 602, it snaps back, spring-like, rotating to the rest position shown, thereby closing the loop. Rotation of the arm 602 is suggested by the arrow 603 in the figure. The pivot 604 allows the hook 601 portion to rotate relative to the loop 170. FIG. 6b is a variant having a rectangular loop 170 and no pivot 604. Other clasps might have the rectangular loop 170 oriented perpendicular to the one shown. A buckle might also be used as a quick release 600, and might also serve as a length-adjuster.

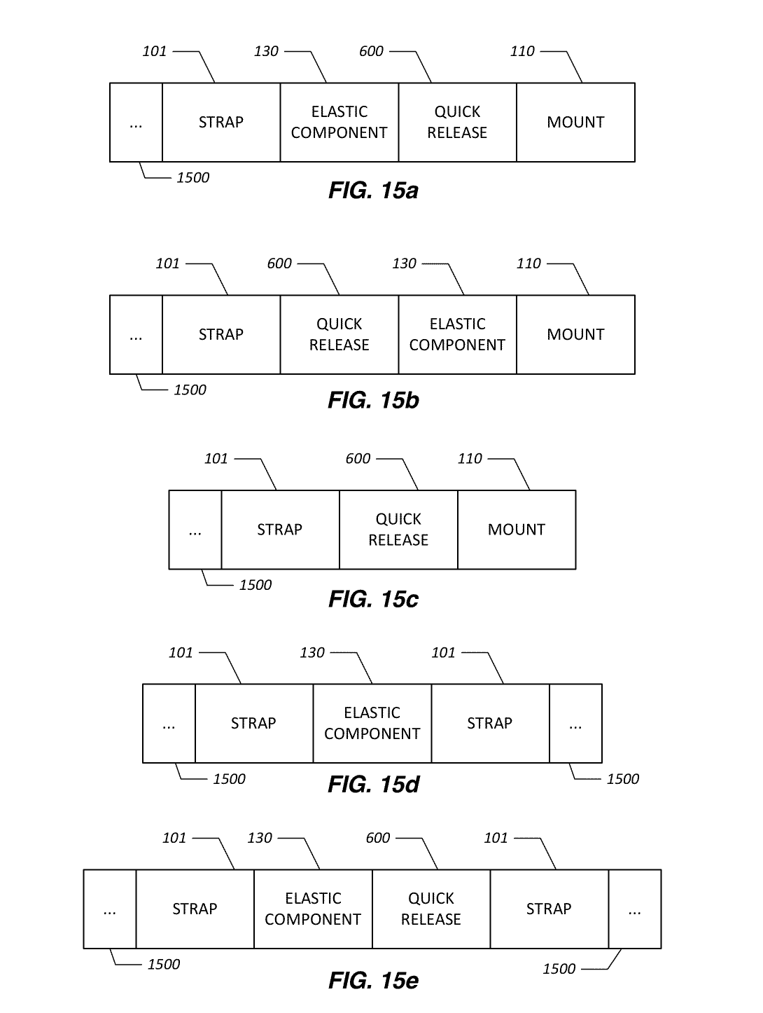

A quick release 600 that splits the tether 100 into two disconnected subassemblies at a single point is particularly convenient. For example, any of the quick release 600 components of FIG. 11-14 might be incorporated into the connection between the loop 170 and the wall mount 112 of FIG. 1f or 1a; or between the loop 170 and the appliance mount 111 of FIG. 1g or 1c. See FIG. 15a-15c.

FIG. 7 shows a D-ring 700 that might be used to couple two components in a tether 100; for example, two sections of strap 101; strap 101 to quick release 600; strap 101 to appliance 120; or elastic component 130 to strap 101.

FIG. 8 shows a length-adjustment slide 800. FIG. 9 is a conceptual view showing a strap 101 configuration in which a slide 800 can be used for length adjustment. This figure also illustrates loops loop 900, loop 901 formed from strap 101 fabric by standard techniques such as stitching, stapling, thermal sealing, or gluing. Other types of standard length adjustment structures and methods are included within the scope of the invention. For example, a length strap 101 containing the hooks portion of a hook-and-loop fastener might be folded onto another length containing the loops portion.

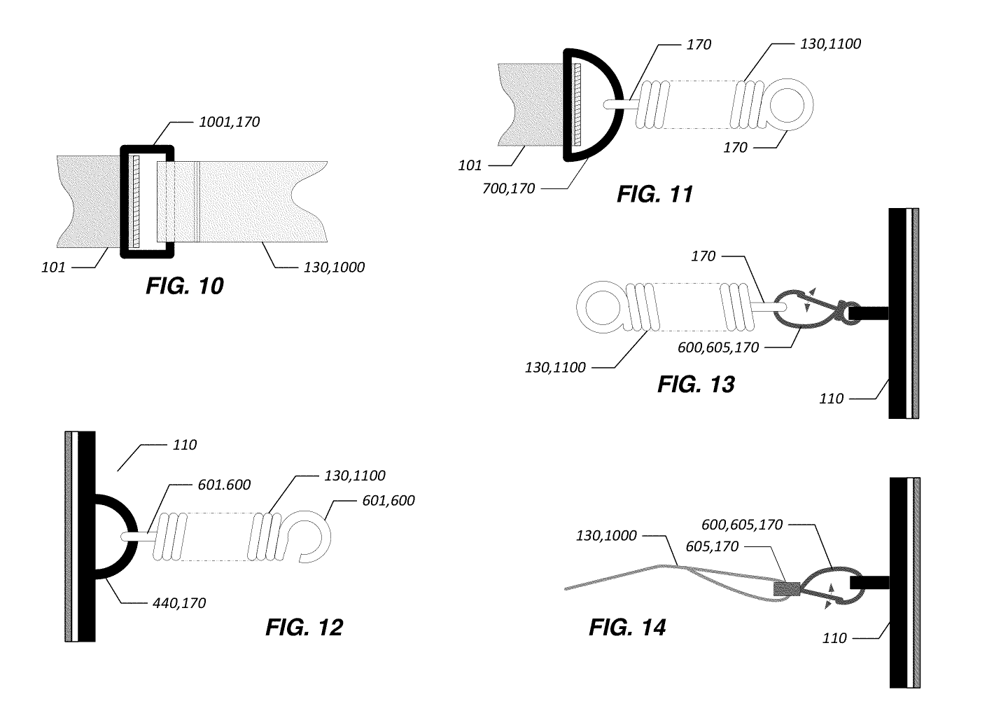

In certain elastic components 130, such as the elastic material 1000 shown in FIG. 10, similar techniques may form loops 170 as needed in a given tether 100 configuration. The figure shows a strap 101 joined to the elastic material 1000 at a rectangular loop 1001. FIG. 11 shows another coupling of an elastic component 130, in this case a spring 1100 to a D-ring 700. FIG. 12 shows another spring 1100, having a hook 601 at the surface-mount 110 end, allowing this elastic component 130 to double as a quick release 600. FIG. 13 shows a quick release 600, which is attached to a monitor 127, and snapped to an elastic component 130. FIG. 14 shows a quick release 600, which is attached to a strap 101, and snapped to a surface-mount 110.

FIG. 15a-15e show various exemplary orderings of components that might be coupled together in a tether 100. A component 1500 of three dots indicates the remainder of the tether 100. Note that the figure shows orderings, not necessarily sequences—here might be an intermediate hidden component used to couple the two shown components, conceptually along the vertical line separating those two components. In FIG. 15e, for example, a strap 101 may be connected to an elastic component 130 as shown in FIG. 10 or FIG. 11 at an intermediate loop 170.

To exemplify application of FIG. 15a-15e, we note that several of the embodiments discussed so far have been V-shaped; or Y-shaped where one segment of the ‘Y’ is an elastic component 130 and some connectors, as in FIG. 1g. Embodiments of tethers 100 having a more pronounced Y-shape might be constructed, for example, using the sequence of FIG. 15a, where the mount 110 is a wall mount 112 and the three dots 1500 are replaced with a loop 170 and the V-shaped prongs of the ‘Y’ from FIG. 1g, with the strap 101 permitting swivel passing unrestricted through the loop 170. Many other configurations are possible by utilizing aspects from the various figures shown.

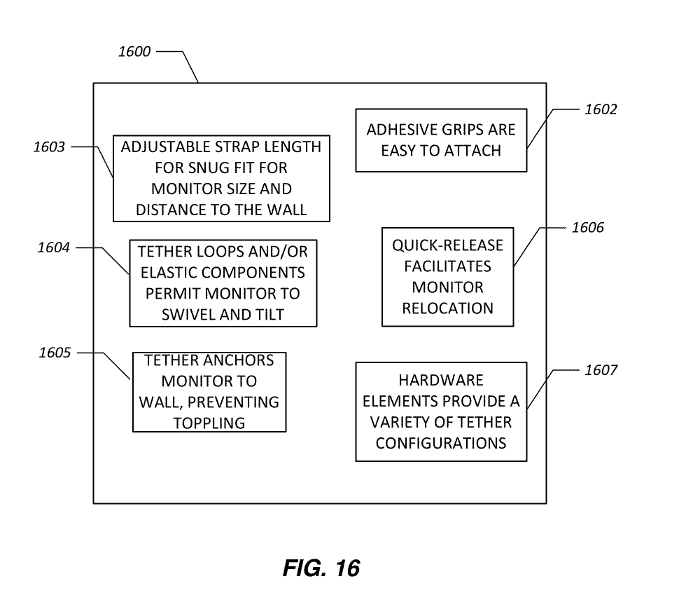

FIG. 16 is a summary of various features or advantages 1600, some or all of which may be included in various embodiments of the invention. These include: adhesive grips are easy to attach 1602; adjustable strap length for snug fit for appliance size and distance to the wall 1603; tether loops and/or elastic components permit appliance to swivel and tilt 1604; tether anchors appliance to wall 1605; quick-release (especially single-point quick release) facilitates appliance relocation 1606; and hardware elements provide a variety of tether configurations 1607.

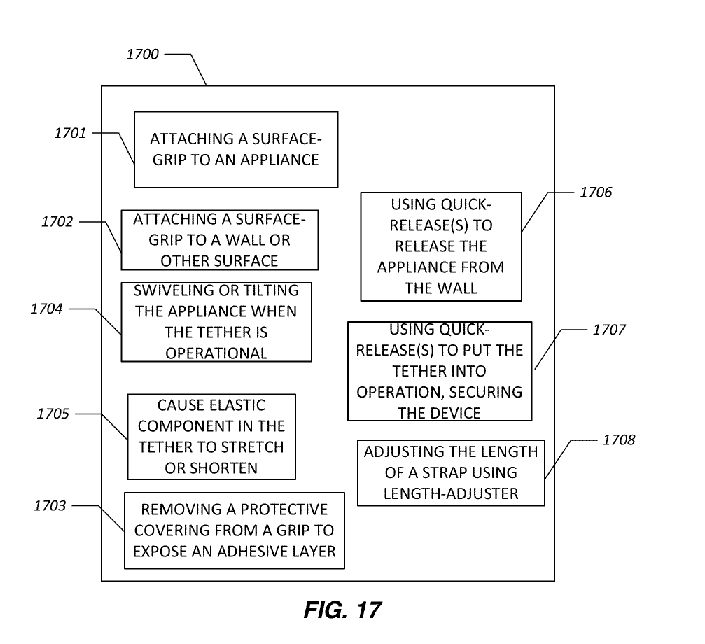

FIG. 17 lists a set of method steps 1700 that might be done with an anti-toppling tether 100 of the invention. Any of these steps, alone or in combination with each other or with other steps, and in any order, with such a tether 100, is a method within the scope of the invention. These steps include: attaching a surface-grip to an appliance 1701; attaching a surface-grip to a wall or other surface 1702; swiveling or tilting the appliance when the tether is operational 1704; cause elastic component in the tether to stretch or shorten 1705; removing a protective covering from a grip to expose an adhesive layer 1703; using quick-release(s) to release the appliance from the wall 1706; using quick-release(s) to put the tether into operation, securing the device 1707; and adjusting the length of a strap using length-adjuster 1708.

Of course, many variations of the above method are possible within the scope of the invention. The present invention is, therefore, not limited to all the above details, as modifications and variations may be made without departing from the intent or scope of the invention. Consequently, the invention should be limited only by the following claims and equivalent constructions.

What is claimed is:

1. A set of tether components, comprising:
a) a first, a second, and a third surface-mount;
b) a loop; and
c) a strap, attached to the first and the third surface-mounts, and passing through the loop but not secured to the loop,
such that, when the tether is in a restraining configuration, the set of tether components are directly or indirectly physically coupled to each other.

2. The set of tether components of claim 1, the set of components further comprising:
d) an elastic component, which is coupled to the loop.

3. The set of tether components of claim 2, wherein the elastic component is also coupled to the second surface-mount.

4. The set of tether components of claim 2, wherein the elastic component includes a spring, an elastomer, or a stretchable fabric.

5. The set of tether components of claim 1, wherein the first and third surface-mounts are attached to an appliance, and the second surface-mount is attached to a wall.

6. The set of tether components of claim 5, wherein the appliance is a television or monitor.

7. The set of tether components of claim 1, wherein the first and third surface-mounts are attached to a wall, and the second surface-mount is attached to an appliance.

8. The set of tether components of claim 5, wherein the appliance is a television or monitor.

9. The set of tether components of claim 1, further comprising:
d) a nonempty set of quick-releases, such that
(i) when the tether is in the restraining configuration,
(A) each quick-release is directly coupled to a respective first component in the set of components, and can be decoupled from its respective mating component manually without tools, and
(B) decoupling a subset of the set of quick-releases from their respective mating components converts the tether into a split configuration, wherein a split configuration is a configuration in which all wall mounts are in a first subassembly and all appliance mounts are in a disconnected second subassembly, and
(ii) each quick-release that is decoupled from its respective mating component can be coupled to that component manually without tools.

10. The set of tether components of claim 9, wherein decoupling a single quick-release from its respective mating component converts the tether from the restraining configuration into a split configuration.

11. The set of tether components of claim 9, wherein a quick-release in the set of quick-releases includes a clasp, a hook, a buckle, or a hooks-and-loops fastener.

12. The set of tether components of claim 1, further comprising:
d) a length-adjuster, which is coupled to a strap in the set of tether components when the tether is in the restraining configuration.

13. The set of tether components of claim 12, wherein the length-adjuster includes a slide, a buckle, or a hooks-and-loops fastener.

14. The set of tether components of claim 1, wherein a surface-mount is attached to an appliance.

15. The set of tether components of claim 1, wherein a surface-mount includes an adhesive layer.

16. A tether, comprising:
a) a first and a second surface-mount;
b) an elastic component; and
c) a strap.

17. The tether of claim 16, further comprising:
d) a loop through which the strap passes, but to which the strap is not secured.

18. The tether of claim 16, wherein the first surface mount is attached to an appliance and the second surface mount is attached to a wall.

19. A method, comprising any of the following steps, alone or in combination:
a) attaching a surface-mount in a tether to an appliance;
b) attaching a surface-mount in the tether to a wall;
c) swiveling or tilting an appliance to which a surface-mount in the tether is attached when the tether is operational;
d) using a quick-release in converting the tether from a restraining configuration into a split configuration;
e) using a quick-release in converting the tether from a split configuration into a restraining configuration;
f) causing an elastic component to elongate or shorten by swiveling or tilting an appliance to which a surface-mount in the tether is attached;
g) after converting the tether from a restraining configuration into a split configuration, moving an appliance to which a surface-mount in the tether was attached;
h) removing a protective covering from a surface-mount in the tether to expose an adhesive layer; and
i) adjusting the length of a strap in the tether using a length adjuster,
wherein the tether includes
(i) a first, a second, and a third surface-mount;
(ii) a loop; and
(iii) a strap, attached to the first and the third surface-mounts, and passing freely through the loop.
